(19) United States
(12) Patent Application Publication
(10) Pub. No.: US 2024/0252382 A1
(43) Pub. Date: Aug. 1, 2024

(54) Massage Tool

(71) Applicant: Dustin Donahue, Cameron, NC (US)

(72) Inventor: Dustin Donahue, Cameron, NC (US)

(21) Appl. No.: 18/102,089

(22) Filed: Jan. 27, 2023

(51) Int. Cl. A61H 7/00

(52) U.S. Cl. CPC A61H 7/003

(57) ABSTRACT

A novel design for massaging the human skin where a plurality of skin-contacting points are created for the manipulation of soft tissue adhesions is disclosed. Each of the points comprises a plurality of curvilinear edge surfaces having different radii for contacting the skin in a plurality of locations. The structure is simple, easy to use, has low manufacturing cost and is convenient to use.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates generally to a hand-held massage tool and, more particularly, it relates to a hand-held manual massage tool, which incorporates a plurality of tools for engaging the skin of an area to be massaged. The tools provide a plurality of curvilinear surfaces of different radii and have a plurality of beveled treatment edges for contacting skin surfaces, thereby facilitating therapeutic massage for a broad array of differing physiologies.

### Description of the Related Art

The massaging of various parts of the body is an old and well-known art. It is well known that massaging relaxes the muscles, improves circulation, and generally improves the feeling of well-being of an individual or patient. It is also believed that massaging has major health benefits. In fact, massage therapy is a popular way to treat a variety of ailments including sore or tired muscles, headaches, minor injuries, stress, poor blood circulation, chronic pain syndromes, and decreases injury rehabilitation time.

Perhaps the oldest and most well-known technique of massaging is the use of the hands and fingers of the massage therapist. While hand and finger massaging is believed to be most beneficial, the hand or finger massage is exhausting for the massage therapist and cannot be self-applied without additional stress to the hands. Continuous massaging stresses the fingers, the thumbs, the hands, and the wrist. For this reason, certain implements have been developed in an effort to provide somewhat equivalent benefit to hand or finger massage and also to enable self-massaging. Unfortunately, one problem with conventional massage tools is that they were not comfortable for the massage therapist to hold and manipulate.

There are multiple inventions that have been proposed in prior art regarding advancements in similar field. For instance, a Korean patent 1,016,88914B1 on Massage tool is issued to Korean inventor. The present invention provides a face skin beautifying vibration massage tool capable of performing massage and improving skin to be modified. To this end, the face skin beautifying vibration massage tool according to the present invention comprises: a body having a contact part formed on the bottom surface thereof to come in contact with skin; an idle roller axially coupled with the front of the body, and rotated to perform an operation of lifting up skin according to an operation of pushing the body while coming in contact with skin; a cam disposed in the body, coupled with a driving motor driving through electrical power supplied from a battery, and eccentrically rotated; and a vibration unit coupled with the outer diameter of the cam, and including a metal ball generating vibration while repeatedly colliding with the inner surface of the contact part according to eccentric rotation of the cam. When the idle roller lifts up skin, the contact part lifts down the skin in the opposite direction of the idle roller through vibration transferred from the vibration unit so as to perform an operation of extending skin between the idler roller and the contact part.

Another patent on Multi-layered massage tool beraing U.S. Pat. No. 1,081,3824B2 is issued to Implus Footcare LLC. The patent is on a multi-layered hand-held massage tool for fascial manipulation includes a weight plate having a first side, a second side opposite from the first side, and an outer edge. The massage tool also includes a first outer layer located on the first side of the weight plate to form a first side of the massage tool, and a second outer layer located on the second side of the weight plate to form a second side of the massage tool. The multi-layered hand-held massage tool has a massage surface, adapted for fascial manipulation, coupling the first side of the massage tool to the second side of the massage tool and covering at least a portion of the outer edge of the weight plate.

Another patent on Massage Tool And Methods Therefor bearing US patent 2,014,0213944A1 is issued to ELC Management LLC. The patent is on a hand-held massage device and methods for applying pressure therapies to various parts of the anatomy using the device are provided. The device is an elongated, rigid, substantially planar member, configured with a series of alternating concave and convex shapes, and a knob-like projecting member at an end thereof.

Another patent on Cylindrical roller massage tool bearing US patent 2,012,0310125A1 is issued to Wendell HallBradley B. PittCherimeer Lynn PittMichele Hall. The patent is on a manually operated cylindrical roller is disclosed which facilitates the even application of pressure to the body tissue of a client during massage therapy, including tendons, ligaments, and muscles (e.g. the gluteus maximus, gluteus medius, sartorius, plantaris, and the like). Variations of the disclosed tool comprise inflatable and non-inflatable components, as well as foam components. The disclosed invention relieves sore and achy muscles, helps blood circulation, relieving muscle cramps, loosening tight and knotted muscles, and relieving pressure from the massage therapist's hands.

A Massage tool bearing US patent 2,015,0272774A1 is issued to Wen-Hwa Lee. The patent is on a massage tool includes a main body; and an active member coupled to the main body. The active member includes an active material capable of being heated for transferring heat to the main body so as to activate or reactivate the massage tool. If necessary, more than one active material may be included in the active member. Heat can be transferred from the active material to the main body by way of conduction of the active material or convection of an active vapor released from the active material. The active vapor, for example, can be steam for providing heat and/or vaporized essential oil for aromatic treatment. The active material, for example, can be heated by an external heating source or an internal heating source.

There are multiple solutions that have been presented in prior art. However, these solutions are limited and restricted to their conventional architecture, installation system and have considerable shortcomings which adversely affect the convenience with which they can be used. The prior systems have certain limitations including the design of assemblies which make them not suitable for every type of user. Moreover, the ease-of-use ability of these assemblies is also questionable.

Therefore, it would be advantageous to design a device that is a simple massage tool that is handheld and allows the massager to apply pressure easily and can be used for all body parts.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a massager assembly.

Another object of the present invention is to provide an improved form of a gentle and effective massage, to improve blood circulation and to make it possible to handle difficult locations which one should approach with care in confined spaces.

Another object of this invention is to provide a new and improved assembly that relates to a massage tool, which functions in a more efficient way and achieves better performance than the prior art.

It is an object of the invention in one of its aspects to provide a device that is suitable for self-massage and as such is appropriate for home use.

It is also the objective of the invention to provide a smart design that is easy to hold, easy to massage, and easy to hold, thus relaxing the massager's hands from massaging pressures and continuous usage.

It is a further aspect of the present invention to provide a new and improved assembly that is developed from high-quality material and maintains its effectiveness over a longer period of time.

Thus, it is the objective to provide a new and improved assembly of massager tool. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

Non-limiting and non-exhaustive embodiments of the present invention are described with reference to the following drawings. The system and method of the present invention will now be described with reference to the accompanying flow chart drawing figure, in which:

FIG. 1 shows the complete view of the assembly as per preferred embodiments of the invention;

FIG. 2 shows another view of the assembly as per preferred embodiments of the invention;

FIG. 3 shows the configuration of the assembly as per preferred embodiments of the invention;

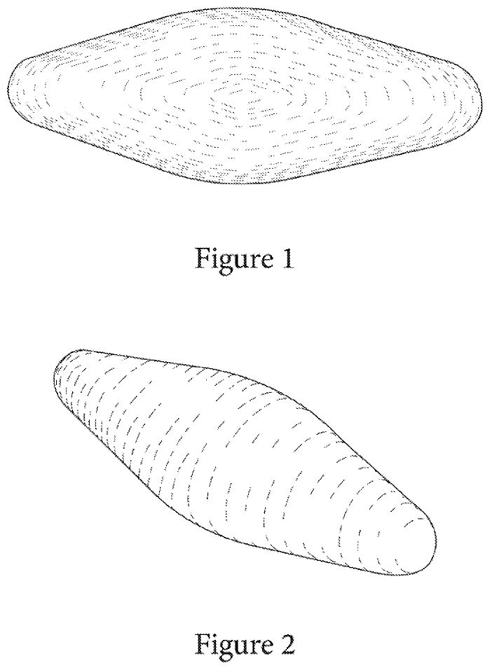

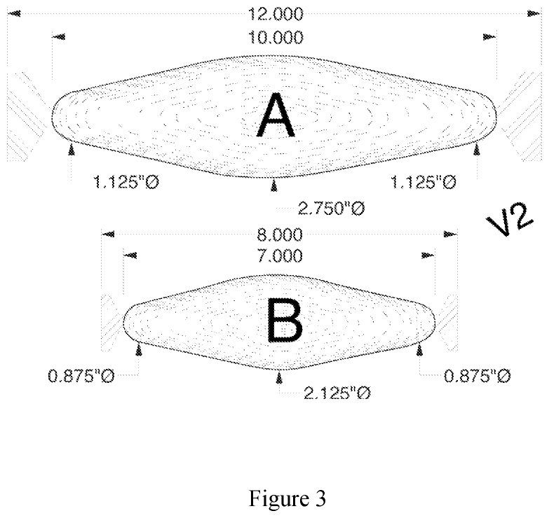

Skilled artisans will appreciate those elements in the figures are illustrated for simplicity and clarity and have not necessarily been drawn to scale. For example, the dimensions of some of the features in the figures may be exaggerated relative to other elements to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide an improved structure of massage tools.

Typically, the human body needs the right amount of blood flow to keep your heart pumping, your legs moving and your brain functioning. Blood circulation, the movement of blood throughout the body, is clearly crucial to your existence, and preventing poor foot circulation should be a high priority.

A person with poor circulation can suffer from a variety of discomforts including pooling of the fluid in the extremities (like the toes), cold hands and feet, fatigue, and achiness created by an accumulation of lactic acid in the muscles. Good circulation brings damaged, tense muscles the oxygen rich blood they need to heal.

Massage facilitates circulation because the pressure created by the massage technique actually moves blood through the congested areas. The release of this same pressure causes new blood to flow in. The squeezing and pulling also flush lactic acid from the muscles.

The current invention as per its preferred embodiments is an improved design of a massage tool that the user can apply on the body to gain massaging comfort. The assembly is developed from non-corroding metals or alloys, plastic or wood which has two long sides (a) and (b) wherein the side (a) and side (b) is a concave curvature, straight, curved, or structured.

The use of the device is simple. The user sweeps the skin massager tool with pressure, preferentially under an acute angle, e.g. 20° over the skin surfaces. By varying the applied pressure it is possible to achieve comfort on the skin. The treatment is very simple and can easily be carried out by the users/massagers sitting or lying. Theoretically, all parts of the body are reachable, also possible is the implementation by a trained specialist or normal user.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A skin massager tool wherein:
The massage tool as per claim 1, wherein first and second long sides, wherein the first long side has a concave curvature, and the second side has a concave curvature;
The massage tool as per claim 1, wherein the center part bulges out;
The massage tool as per claim 1, wherein the method of using the device, comprises a step of massaging the skin with the proposed device for massaging and treating all body parts to relax and soothe the human body.
